(19) United States
(12) Patent Application Publication
(10) Pub. No.: US 2025/0113805 A1
(43) Pub. Date: Apr. 10, 2025

(54) ANIMAL HUSBANDRY SYSTEM

(71) Applicant: LELY PATENT N.V., Maassluis (NL)

(72) Inventors: Karel VAN DEN BERG, Bleskensgraaf (NL); Korstiaan Cornelis BLOKLAND, Goudriaan (NL); Paulus Jacobus Maria VAN ADRICHEM, Delfgauw (NL); Martinus Cornelis Johannes BUIJS, Heerle (NL)

(73) Assignee: LELY PATENT N.V., Maassluis (NL)

(21) Appl. No.: 18/729,087

(22) PCT Filed: Jan. 17, 2023
(86) PCT No.: PCT/IB2023/050397

§ 371 Date: Jul. 15, 2024

(30) Foreign Application Priority Data
Jan. 27, 2022 (NL) 2030751

(51) Int. Cl. A01K 29/00; H05B 47/115

(52) U.S. Cl. CPC A01K 29/005; H05B 47/115

(57) ABSTRACT

An animal husbandry system, wherein a group of animals can move about freely in an area, includes monitoring and analyzing device configured for repeatedly generating images and gathering data therefrom regarding at least one mobile being and/or object in the area, an illumination device provided with a number of illumination elements, each arranged for illuminating at least a subarea of the area, and a controller connected to the monitoring and analyzing device and to the illumination device. The monitoring and analyzing device is configured for determining an image quality value for each generated image and for detecting an insufficient image quality due to an unsuitable illumination intensity in at least one of the subareas. The control device is configured for adjusting said unsuitable illumination intensity in said subarea to a suitable illumination intensity, so that the image quality becomes sufficient.

The present invention relates to an animal husbandry system, wherein a group of animals can move about freely in an area.

Such systems are widely known in the art. Monitoring the animals in the system and gathering relevant and reliable data plays an important role in such systems.

EP3335551 discloses a method of monitoring livestock inside of a building using a camera and a light assembly arranged above the livestock for gathering tracking data relating to a motion of a tracked individual animal. A measured light condition in the building may be compared with stored reference values and corrected. WO2014/118788 discloses an optical monitoring system for livestock in which various activities and parameters may be monitored and measured to determine the health state of the population of animals, in particular chickens. In some areas a resolution enhancer is used. WO2011/039112 shows an animal behaviour monitoring system in which several animal movement patterns are derived from recorded image data. WO2015/104250 divulges a method and system of livestock rearing in which the illumination in a shed is optimized by means of controlling fixedly arranged lights individually dependent on signals from cameras. The prior art systems and methods have several drawbacks. The flexibility of the illumination is poor. The quality of the images provided by the cameras is not monitored, which affects the quality of the data gathered, especially in an often heavily polluted animal husbandry environment.

There is a need for an improved system with a flexible, yet precise illumination.

It is an object of the present invention to provide such an improved system.

The invention achieves the object at least in part by means of a system according to claim 1, in particular an animal husbandry system, wherein a group of animals can move about freely in an area, the system comprising
monitoring and analyzing means configured for repeatedly generating images and gathering data therefrom regarding at least one mobile being and/or object in the area,
illumination means provided with a number of illumination elements, each arranged for illuminating at least a subarea of the area, and
control means connected to the monitoring and analyzing means and to the illumination means,
   wherein the monitoring and analyzing means are configured for determining an image quality value for each generated image and for detecting an insufficient image quality due to an unsuitable illumination intensity in at least one of the subareas, wherein the control means are configured for adjusting said unsuitable illumination intensity in said subarea to a suitable illumination intensity, so that the image quality becomes sufficient.

In this way, a highly useful, flexible and user-friendly system is realized. The invention is based on the insight that a simple, yet efficient and automated enhancement of the images generated in the system can be achieved by locally adjusting the illumination intensity if required. A targeted adjustment is rendered possible, improving energy efficiency. No additional sensors are needed. The quality of the data gathered in the system is improved.

Suitable and advantageous embodiments are described in the dependent claims, as well as in the description below.

According to a first embodiment of the invention, the monitoring and analyzing means are configured for tracking at least one mobile being and/or object in the area by means of tracking data gathered from the repeatedly generated images. In an animal husbandry system it is very useful to be able to track animals and objects in the area accurately. The accuracy is enhanced by the possible adjustment of the illumination intensity.

According to a further embodiment, the at least one mobile being and/or object in the area comprises an animal. This is a very practical embodiment allowing for monitoring and/or tracking a (part of a) group of animals in the area.

In yet another embodiment, the at least one mobile being and/or object in the area comprises a vehicle. It is useful to be able to monitor and/or track a vehicle in case such a vehicle is present in the area.

Advantageously, at least one of the illumination elements is suitable for illuminating a moveable subarea of the area. In this way, tracking is facilitated.

According to a further embodiment, the control means are configured for controlling the illumination element(s) suitable for illuminating a moveable subarea of the area, in response to the tracking data from the monitoring and analyzing means, in such a way that the tracked mobile being and/or object in the area is being substantially continuously illuminated with a suitable illumination intensity. This constitutes a highly advantageous embodiment, enabling efficient and very accurate tracking.

In accordance with a further embodiment, the vehicle is provided with reflector means. This facilitates tracking of the vehicle.

Advantageously, the vehicle is provided with navigation means, the control means being configured for calibrating the navigation means. The enhanced tracking rendered possible by the illumination intensity adjustment allows for a calibration.

In yet a further embodiment, the system is provided with localization means for the at least one mobile being and/or object in the area, the control means being configured for controlling the illumination element(s), in response to localization data from the localization means, in such a way that a selected mobile being and/or object in the area is illuminated with a suitable illumination intensity. This is highly advantageous for gathering reliable data on selected animals or vehicles.

According to a further embodiment of the invention, the system is provided with event detection means for detecting specific events related to the at least one mobile being and/or object in the area, the control means being configured for controlling the illumination element(s), in response to data from the event detection means, in such a way that mobile beings and/or objects in the area which are involved in the detected event are illuminated with a suitable illumination intensity. In this way, data gathering on specific events in the barn is rendered possible.

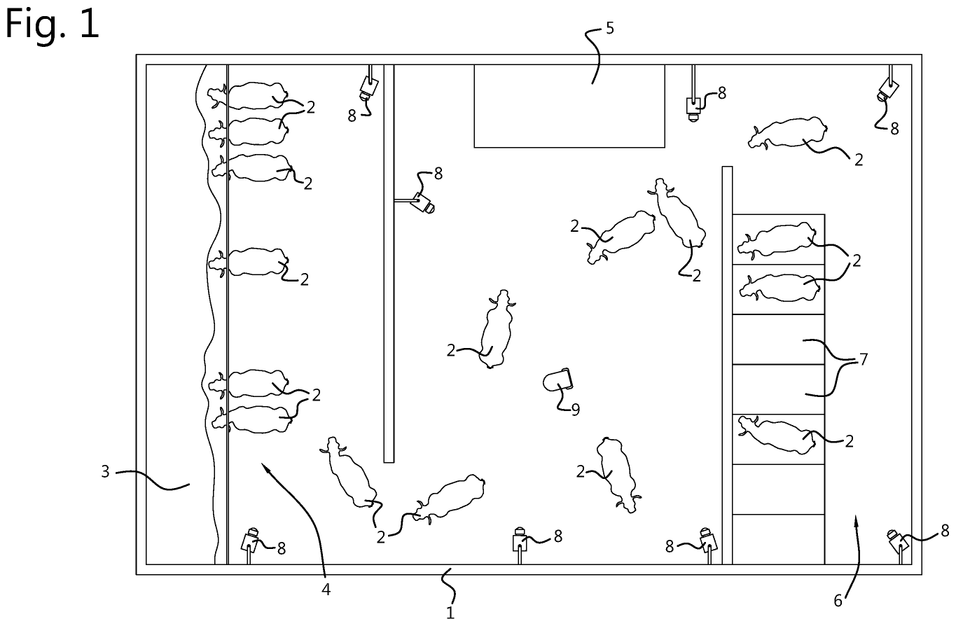

FIG. 1 shows an area with an animal husbandry system according to the invention.

FIG. 1 shows an animal husbandry system with an area 1, here shown as a stable or shed or barn 1, wherein a group of animals 2 can move about freely. In the example shown the animals are cows. Of course, the invention can also be applied to an animal husbandry system involving other animals, such as goats, pigs, horses, chickens, turkeys, etcetera. The area 1 can also be a structure with, for example, a partly open roof. The system according to the invention can in principle also be applied in an open area like a meadow or pasture with cattle fences.

The stable 1 has a feed alley 3, a feeding and/or drinking area 4 for the cows 2, a milking robot 5 for the cows 2 and a resting area 6 for the cows 2 with cubicles 7. One or more water troughs (not shown) may be placed in the area 4.

Furthermore, monitoring and analyzing means are provided, here in the form of a number of video cameras 8. Illumination means provided with a number of illumination elements (not shown) are also provided, each illumination element being arranged for illuminating at least a subarea of the area or shed 1. The illumination elements are suitable for illuminating respective different (possibly partly overlapping) regions. Collectively, the illumination elements are suitable for illuminating substantially the whole area or shed 1. The illumination elements may be combined with or integrated in the cameras 8, but they can also be provided separately.

Control means connected to the monitoring and analyzing means and to the illumination means are also provided (not shown). The control means may comprise a computer or any other suitable processing means. They can also be located outside or at a distance from the area or shed 1. Video analyzing means, known as such, can be incorporated in the cameras 8, or in the control means.

The cameras 8 are arranged for monitoring a region or a subarea or a number of subareas of the stable 1. Of course, other optical sensors can in principle be used also. The cameras 8 are provided in such a way that, collectively, they are suitable for monitoring substantially the complete area 1, particularly the animals 2 and the shed floor. The cameras 8 can be provided in the shed 1 above the animals 2, or as shown in FIG. 1, pivotably mounted on the walls of the shed 1. They can be positioned and oriented in such a way that all relevant subareas of the area 1 can be monitored. The subareas may overlap. In case the invention is used in a pasture, the cameras 8 may be provided on fences, at a sufficient height above the ground.

The monitoring and analyzing means 8 are configured for repeatedly generating images and gathering data therefrom regarding at least one mobile being and/or object in the area 1. The mobile being can e.g. be an animal 2 or a human being (not shown). The mobile object can e.g. be a vehicle 9 in the area 1. The data gathering can be performed with the video analyzing means in a manner known as such, using image processing techniques. Use can also be made of artificial intelligence techniques (known as such), such as machine learning or deep learning, e.g. using neural networks.

In the example shown, there are eight cameras 8. The chosen configuration obviously depends on the shape of the area or shed 1.

An unmanned vehicle 9, for example used for cleaning purposes and known as such, can be moved about in the area 1 by means of the control means. The unmanned vehicle 9 will normally move about with the aid of its navigation system and visit each and every corner of the area 1. The vehicle 9 can comprise sucking means suitable for sucking up dirt and a collector for collecting the dirt. Its drive means can be charged at a base station 15 in, at or near the stable 1 with means for charging the vehicle's batteries (not shown, known as such). Of course, also other mobile objects can be present in the area 1.

When keeping animals 2 in an area 1, it is often desirable to monitor the animals 2 and/or to gather specific animal data. In accordance with the invention, individual animal data 20 can be reliably gathered, although the animals 2 are allowed to move about freely in the area 1. Such data can relate not only to the position and/or movements of the animals 2, but also to certain behaviours of the animals 2, or to specific events in the area 1 involving the animals 2, as will be elucidated below. Besides, other mobile beings, such as humans, which are present in the area 1 can also be monitored. Of course, also data relating to 25 the vehicle 9 or any other mobile object in the area 1 may be gathered.

In the animal husbandry system according to the invention, the monitoring and analyzing means 8 are configured for determining an image quality value for each generated image and for detecting an insufficient image quality due to an unsuitable illumination intensity in at least one of the subareas, wherein the control means are configured for adjusting said unsuitable illumination intensity in said subarea to a suitable illumination intensity, so that the image quality becomes sufficient. A simple, yet efficient and automated enhancement of the images generated in the system is achieved by locally adjusting the illumination intensity, if required. Thus, a targeted adjustment is rendered possible, without the need for any additional sensors. The quality of the data gathered in the system is improved, rendering the system highly useful, flexible and user-friendly.

Also, the energy efficiency of the system is improved. For example, when illumination elements cover overlapping regions, then the illumination intensity can be locally reduced in order to avoid an insufficient image quality due to too much brightness. Contrariwise, in dark spots the illumination intensity can be locally increased.

The monitoring and analyzing means 8 are configured for tracking at least one mobile being 2 and/or object in the area by means of tracking data gathered from the repeatedly generated images. In an animal husbandry system it is very useful to be able to determine and/or track the position of animals 2 and objects in the area 1 accurately. The accuracy is enhanced by the possible adjustment of the illumination intensity. It allows for monitoring and/or tracking a (part of a) group of animals 2 in the area 1. It is also useful to be able to monitor and/or track a vehicle 9 present in the area 1.

Advantageously, at least one of the illumination elements is suitable for illuminating a moveable subarea of the area 1. Such an illumination element can e.g. be mounted pivotably, under the control of the control means. The subarea is thus adjustable. In this way, tracking is facilitated. Moving animals 2 or vehicles 9 can be followed by the relevant illumination elements.

The control means are configured for controlling the illumination element(s) suitable for illuminating a moveable subarea of the area 1, in response to the tracking data from the monitoring and analyzing means 8, in such a way that the tracked mobile being 2 and/or object 9 in the area 1 is being substantially continuously illuminated with a suitable illumination intensity. This constitutes a highly advantageous embodiment, enabling efficient and very accurate tracking. The enhanced local illumination is targeted and continuous, so that e.g. cows 2 can be excellently tracked.

The vehicle 9 can be provided with reflector means. This facilitates tracking of the vehicle 9. The vehicle 9 is usually provided with navigation means. In accordance with an aspect of the invention, the control means are configured for calibrating the navigation means. The enhanced tracking rendered possible by the illumination intensity adjustment allows for such a calibration.

The system is provided with localization means for the at least one mobile being 2 and/or object 9 in the area 1, the control means being configured for controlling the illumination element(s), in response to localization data from the localization means, in such a way that a selected mobile being 2 and/or object 8 in the area 1 is illuminated with a suitable illumination intensity. This is highly advantageous for gathering reliable data on selected animals 2 or vehicles 9, which are accurately illuminated.

The localization means may comprise additional identification means for identifying individual animals 2 in the area 1. This can be done in various ways, known as such. For example, Radio Frequency Identification with tags/transponders and an antenna with a reader can be used. Alternatively, image analysis can be used with the aid of the video monitoring and analyzing means 8, e.g. recognizing the spotted pattern on the back of cows 2. Images of all cameras 8 can be combined to track each cow 2 in the whole barn 1. A further possibility involves resetting the position of an animal 2 every time it visits a certain known location, for example when a cow 2 visits the milking robot 5, and then tracking the animal 2 from that known location using the monitoring means 8. Knowing the exact location of the animals 2 in the area 1 has a lot of advantages: individual animal data can be gathered.

The system is provided with event detection means for detecting specific events related to the at least one mobile being 2 and/or object 9 in the area 1, the control means being configured for controlling the illumination element(s), in response to data from the event detection means, in such a way that mobile beings 2 and/or objects 9 in the area 1 which are involved in the detected event are illuminated with a suitable illumination intensity. In this way, data gathering on specific events in the barn 1 is rendered possible.

For example, cows may be mounting or attempting to mount other cows, as they are in heat. This can be monitored by the system. The animals 2 involved can be tracked accurately. This is highly useful for the farmer. Moreover, the data can be used to improve animal health and welfare.

So the system allows cows 2 or other objects 9 to be monitored and/or tracked, specifically selected animals 2 to be monitored and/or tracked, and monitoring specific situations, behaviours or events in the area 1.

The image quality value determined for each image by the monitoring and analyzing means 8 may depend on the type of data gathered. For the mere tracking of a cow 2 a certain image quality may suffice, whereas for the monitoring of a certain behaviour the same image quality may be insufficient, as more detail is necessary therefor. Thus, the illumination adjustment may also be performed in dependence on the type of data gathered.

Especially in an agricultural environment, heavy pollutions are likely to occur, rendering a generated image unsuitable for the gathering of data regarding the animal 2 or the vehicle 9 in the area 1. This is efficiently remedied by the present invention.

### REFERENCE NUMERAL LIST

1 area, stable
2 cow
3 feed alley
4 feeding and/or drinking area
5 milking robot
6 resting area
7 cublicle
8 camera
9 unmanned vehicle

1. An animal husbandry system, wherein a group of animals can move about freely in an area, the system comprising:
monitoring and analyzing means configured for repeatedly generating images and gathering data therefrom regarding at least one mobile being and/or object in the area;
illumination means provided with a number of illumination elements, each illumination element being arranged for illuminating at least a subarea of the area; and
control means connected to the monitoring and analyzing means and to the illumination means,
wherein the monitoring and analyzing means are configured for determining an image quality value for each generated image and for detecting an insufficient image quality due to an unsuitable illumination intensity in at least one of the subareas, wherein the control means are configured for adjusting said unsuitable illumination intensity in said subarea to a suitable illumination intensity, so that the image quality becomes sufficient.

2. The system according to claim 1, wherein the monitoring and analyzing means are configured for tracking the at least one mobile being and/or the object in the area by means of tracking data gathered from the repeatedly generated images.

3. The system according to claim 1, wherein the at least one mobile being and/or the object in the area comprises an animal.

4. The system according to claim 1, wherein the at least one mobile being and/or the object in the area comprises a vehicle.

5. The system according to claim 2, wherein at least one of the illumination elements is suitable for illuminating a moveable subarea of the area.

6. The system according to claim 5, wherein the control means are configured for controlling the illumination element(s) suitable for illuminating a moveable subarea of the area, in response to the tracking data from the monitoring and analyzing means, in such a way that the tracked mobile being and/or object in the area is being substantially continuously illuminated with a suitable illumination intensity.

7. The system according to claim 4, wherein the vehicle is provided with reflector means.

8. The system according to claim 4, wherein the vehicle is provided with navigation means, the control means being configured for calibrating the navigation means.

9. The system according to claim 1, wherein the system is provided with localization means for the at least one mobile being and/or the object in the area, the control means being configured for controlling the illumination element(s), in response to localization data from the localization means, in such a way that a selected mobile being and/or object in the area is illuminated with a suitable illumination intensity.

10. The system according to claim 1, wherein the system is provided with event detection means for detecting specific events related to the at least one mobile being and/or object in the area, the control means being configured for controlling the illumination element(s), in response to data from the event detection means, in such a way that mobile beings and/or objects in the area which are involved in the detected event are illuminated with a suitable illumination intensity.

11. The system according to claim 2, wherein the at least one mobile being and/or the object in the area comprises an animal.

12. The system according to claim 2, wherein the at least one mobile being and/or the object in the area comprises a vehicle.

13. The system according to claim 3, wherein the at least one mobile being and/or the object in the area comprises a vehicle.

14. The system according to claim 3, wherein at least one of the illumination elements is suitable for illuminating a moveable subarea of the area.

15. The system according to claim 4, wherein at least one of the illumination elements is suitable for illuminating a moveable subarea of the area.

16. The system according to claim 5, wherein the vehicle is provided with reflector means.

17. The system according to claim 6, wherein the vehicle is provided with reflector means.

18. The system according to claim 5, wherein the vehicle is provided with navigation means, the control means being configured for calibrating the navigation means.

19. The system according to claim 6, wherein the vehicle is provided with navigation means, the control means being configured for calibrating the navigation means.

20. The system according to claim 7, wherein the vehicle is provided with navigation means, the control means being configured for calibrating the navigation means.
